(19) United States
(12) Patent Application Publication
(10) Pub. No.: US 2005/0134447 A1
(43) Pub. Date: Jun. 23, 2005

(54) Automobile indicator

(76) Inventor: Wen-Wei Su, Guei Shan (TW)

Correspondence Address: TROXELL LAW OFFICE PLLC, SUITE 1404, 5205 LEESBURG PIKE, FALLS CHURCH, VA, 22041, US

(21) Appl. No.: 10/740,638

(22) Filed: Dec. 22, 2003

(51) Int. Cl. B60Q 1/22

(52) U.S. Cl. 340/463

(57) ABSTRACT

An automobile indicator is mounted to an automobile to automatically indicate a turning angle and direction of the automobile. The indicator includes a sensor that detects a rotation angle of a steering wheel of the automobile add a control device received a signal from the sensor and issuing a control signal to a plurality of light-emitting elements arranged in a desired configuration for lighting the light-emitting elements in dynamic and variable patterns. The indicator can be implemented by and incorporated in an existing automobile part, such as indicator light, brake light, head-up display, rearview mirror module and auxiliary brake light module. Alternatively, the indicator can be independently mounted to the automobile.

### BACKGROUND OF THE INVENTION

1. Field of the Invention

The present invention relates generally to indicator lights of automobile, and particular to an automobile indicator comprising a number of light-emitting elements dynamically showing turning/moving status of an automobile.

2. The Related Art

Among all transportation vehicles, automobiles are the one that is most commonly used in daily living for general consumers. Due to the high speed of automobile moving along for example a high way, driving safety is one of the major concerns to both the general consumers and the automobile industry. Indicator lights that are mounted on both left and right sides of front and rear portions of an automobile help the drivers of following cars to identify the action that the driver of the automobile is going to take thereby effectively eliminating the risk of traffic accidents. For example, when a leading car is going to switch from the current lane of a high way to for example the lane of the left hand side, the drivers of the cars that follow the leading car and that are currently moving along the left hand side lane must be informed in advance for driving safety purposes. The left indicator light of the leading car is turned on for flashing, generally with light of orange or yellow color, to warn the drivers of the following cars and the cars currently at the left hand side lane. However, absent-minded drivers or lazy drivers may not switch on the indicator light, which brings the risk that deceleration and leftward movement of the leading car is not held attention from the following cars and the left lane cars and as a consequence, the following cars or the left lane cars may collide the leading car under this circumstance.

Automatic indictors that are automatically turned on to indicate the turning or lane-switching of a leading car is available, of which an example is U.S. Pat. No. 5,673,019, which discloses an automatic turn signal and safety device illustrated in FIG. 1 of the attached drawings. The device comprises six left lamps L1-L6 arranged at the left side of an automobile and six right lamps R1-R6 arranged at the right side of the automobile. Both the left lamps L1-L6 and the right lamps R1-R6 are grouped in three sets. A disc 10 is sleeved around a steering column 20 of the automobile. Three left disc electrodes 14, 15 and 16 and three right disc electrodes 17, 18 and 19, all being circumferentially-extending arcs having different angular lengths, are formed on the disc 10 and engageable by three wiper electrodes 11, 12 and 13 respectively. When the automobile is moving straightforward and takes no turning action, the wiper electrodes 11, 12 and 13 are located in a neutral area of the disc 10, as shown in FIG. 1.

The left disc electrodes 14, 15 and 16 are electrically connected to three sets of lamps (L1, L2), (L3, L4) and (L5, L6) via wires W1, W2 and W3, respectively, while the right disc electrodes 17, 18 and 19 are electrically connected to three sets of lamps (R1, R2), (R3, R4) and (R5, R6) via wires W4, W5and W6, respectively. When the car is made a slight right turn by slightly rotating the steering wheel, it is only the first wiper electrode 11 engages the first right disc electrode 17 and consequently, an electric current flows from the first right disc electrode 17 to the wire W4, lighting the right lamps R5 and R6. If the car is made further turn by further rotating the steering wheel to an intermediate level, both the first and second wiper electrodes 11, 12 engage the corresponding right disc electrodes 17, 18 and consequently, two sets of the lamps (R5, R6) and (R3, R4) are lighted. Likewise, an even larger turning angle caused by a large angle rotation of the steering wheel lights on all six right lamps R1-R6.

The same operation is applicable to the left turning signals. When the car is made a slight left turn by slighting rotating the steering wheel, only the first wiper electrode 11 engages the first left disc electrode 14 thereby lighting on only the first set of left lamps L1, L2. Further rotating the steering wheel, which represents a large angle rotation of the car, the first and second wiper electrodes 11, 12 respectively engage the first and second left disc electrodes 14, 15 and lights the first two sets of the left lamps (L1, L2) and (L3, L4). An even larger rotation angle of the steering wheel causes all the wiper electrodes 11, 12, 13 to respectively engage the left disc electrodes 14, 15, 16. All the left lamps (L1, L2), (L3, L4), (L5, L6) are lighted.

Therefore, by flashing lamps of different numbers, a clear warning as to how a leading car is going to move is effectively conveyed to the drivers of following cars.

The conventional automatic indicator, although effective in timely conveying warnings of turning and/or lane switching to other drivers, has a complicated circuit with limited functionality. For example, since there are only three small-sized lamps on each side of the automobile, it does not effectively attract the attention of the drivers of the following cars. If the size of the lamps is properly enlarged, the large-sized lamps are adverse to the aesthetic appealing of the outside configuration and decoration.

In addition, the turning angle of the automobile is roughly divided into three ranges, respectively indicated by the three lamps. This may not be precise enough to actually show the intention of the driver in turning or switching lane. However, aesthetic problems occur again if more lamps are added to more precisely indicate the movement of the automobile, not to mention the additional cost and complication of the lamp control circuit caused by adding more lamps.

Further, when the speed of the car gets faster, a much more prominent turn signal is required to notify the drivers of the following cars. This, however, is not discussed in and overcome by the conventional automatic indicator.

Thus, it is desired to have an automatic automobile indicator that eliminates, or at least alleviates, the drawbacks of the conventional automobile indicator.

### SUMMARY OF THE INVENTION

An object of the present invention is to provide an automobile indicator that operates to automatically and precisely indicate the intention of a driver is making a turn or lane switch whereby driving safety is enhanced.

Another object of the present invention is to provide an automobile indicator that is incorporated in an existing automobile accessory for automatically indicating turning and/or lane-switching operation.

A further object of the present invention is to provide an automobile indicator that automatically shows prominent warning of turning and/or lane-switching operation by adoption of various flashing effects to attract the attraction of other drivers thereby enhancing driving safety.

Yet a further object of the present invention is to provide an automobile indicator that display a warning regarding turning/lane-switching operation to both the driver of the automobile and other drivers to help the automobile driver to monitor the turning/lane-switching operation that is being carried out for driving safety.

To achieve the above objects, in accordance with the present invention, there is provided an automobile indicator adapted to be mounted to an automobile to automatically indicate a turning angle and direction of the automobile. The automobile indicator comprises a sensor that detects a rotation angle of a steering wheel of the automobile add a control device received a signal from the sensor and issuing a control signal to a plurality of light-emitting elements arranged in a desired configuration for lighting the light-emitting elements in dynamic and variable patterns. The indicator can be implemented by and incorporated in an existing automobile part, such as indicator light, brake light, head-up display, rearview mirror module and auxiliary brake light module. Alternatively, the indicator can be independently mounted to the automobile.

### BRIEF DESCRIPTION OF THE DRAWINGS

The present invention will be apparent to those skilled in the art by reading the following description of preferred embodiments thereof, with reference to the attached drawings, in which:

FIG. 1 is a schematic view of a conventional automatic indicator for automobile;

FIG. 2 is a block diagram of an automobile indicator constructed in accordance a first embodiment of the present invention;

FIG. 3A is a rear view of an automobile to which two turning indicators that implement the automobile indicator of the present invention are mounted;

FIG. 3B shows all lamps of the automobile indicator are lighted at the same time;

FIG. 3C shows only some of the lamps of the automobile indicator are lighted;

FIGS. 4A to 4D show different lighting modes for automobile turning at different angles;

FIGS. 5A-1, 5A-2 and 5A-3 show different lighting modes for automobile turning at different angles, wherein the automobile indicator of the present invention is embedded in a rearview mirror module;

FIGS. 5B-1, 5B-2 and 5B-3 show another example where the automobile indicator of the present invention is incorporated to a rearview mirror module;

FIGS. 5C and 5D show further examples where the automobile indicator of the present invention is incorporated in a rearview mirror module;

FIG. 5E shows an example where the automobile indicator of the present invention is incorporated in an interior rearview mirror module;

FIG. 6 is a block diagram of an automobile indicator light constructed in accordance a second embodiment of the present invention;

FIG. 7A-1, 7A-2 and 7A-3 show an example where the automobile indicator of the present invention incorporated in an auxiliary brake light;

FIG. 7B-1, 7B-2 and 7B-3 show another example where the automobile indicator of the present invention incorporated in an auxiliary brake light;

FIG. 7C shows a further example where the automobile indicator of the present invention incorporated in an auxiliary brake light;

FIG. 8 shows yet a further example where the automobile indicator of the present invention incorporated in an auxiliary brake light

FIG. 9 is a block diagram of an automobile indicator light constructed in accordance a third embodiment of the present invention;

FIG. 10 shows an example where the automobile indicator of the present invention incorporated in a head-up display;

FIG. 11 is a block diagram of an automobile indicator light constructed in accordance a fourth embodiment of the present invention;

FIG. 12A shows an example of look-up table contained in a microprocessor of the automobile indicator of the present invention;

FIG. 12B shows another example of look-up table contained in a microprocessor of the automobile indicator of the present invention;

FIG. 13 is a block diagram of an automobile indicator light constructed in accordance a fifth embodiment of the present invention;

FIG. 14A is a rear view of an automobile to which the automobile indicator of the present invention is mounted;

FIG. 14B-1, 14B-2 and 14B-3 show different lighting modes for automobile turning at different angles, wherein the automobile indicator of the present invention is mounted to a rear portion of the automobile;

FIG. 15A shows an example of lighting pattern of lamps of the automobile indicator of the present invention;

FIG. 15B shows another example of lighting pattern of lamps of the automobile indicator of the present invention;

FIG. 15C shows a further example of lighting pattern of lamps of the automobile indicator of the present invention;

FIG. 15D shows yet a further example of lighting pattern of lamps of the automobile indicator of the present invention; and

FIG. 16 shows a different arrangement of the lamps of the automobile indicator of the present invention.

### DETAILED DESCRIPTION OF THE PREFERRED EMBODIMENTS

The present invention will now be described more specifically with reference to the following embodiments. It is to be noted that the following description of the preferred embodiments of the present invention are presented herein for purpose of illustration and description only and it is not intended to be exhaustive or to be limited to the precise form disclosed.

It is noted that the automobile turning indicator that is constructed to automatically indicate a turning direction and a turning angle of an automobile can be implemented by or incorporated into currently existent automobile lamps, such as conventional indicator lights, brake lights and even head-up displays according to one aspect of the present invention.

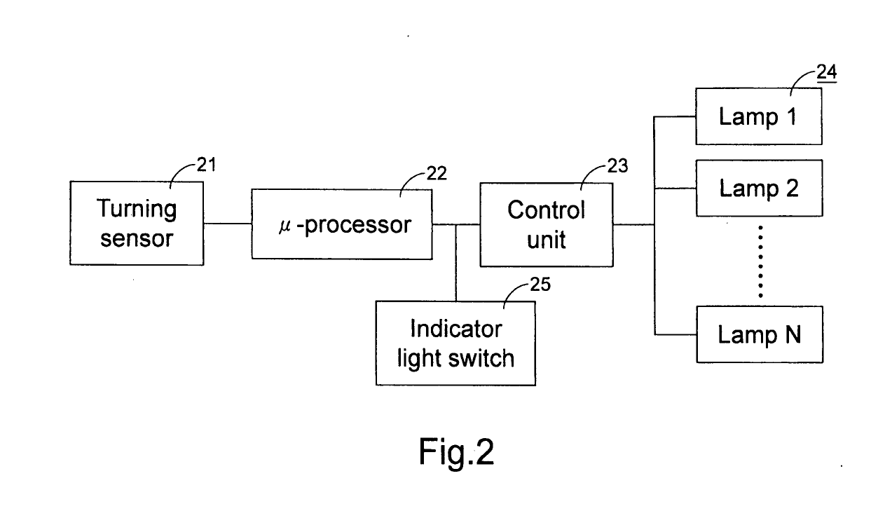

With reference to the drawings and in particular to FIG. 2, an automobile indicator constructed in accordance with a first embodiment of the present invention comprises a turning sensor 21 that is electrically connected to and in communication with a micro-processor 22 and a control unit 23, which under the control of the microprocessor 22, controls a number of lightening units known together as lamps 24, which are named Lamp 1, Lamp 2, . . . , Lamp N in FIG. 2. The lamps 24 may comprises any kind of lighting cells, such as an incandescent lamp, a light emitting diode (LED) and an electro-luminescent (EL) cell. For simplification, they will be referred to as “lamp” hereinafter, but it is noted that the term “lamp” as used herein comprises any suitable lighting cell. An indicator light switch 25 is electrically and mechanically coupled to the control unit 23 for manually enabling/disabling the control unit 23. These parts can be connected to each other by wires or cables, or alternatively, by means of a vehicular digital bus, such as a controller area network (CAN) or a vehicle area network (VAN) bus.

The sensor 21 is mounted to a steering wheel (not shown) of an automobile for detecting a rotation angle of the steering wheel, and generating an electrical signal, such as a digital, signal indicative of the turning direction and the turning angle of the automobile according to the rotation angle of the steering wheel. A commercial sensor, such as 9850 Gen II Series sensor or NCAPS® Thin Profile sensor commercially available from BEI Technologies Inc. (California, USA), can be used to achieve the above purpose.

By operating the indicator light switch 25, a driven inputs a signal indicative of right/left turning to the control unit 23. In response to the signal from the indicator light switch 25, which is, for example, indicative of right turn, the control unit 23 issues a control signal to selectively light on each lamp 24 associated with the right side of the automobile to display a lighting pattern. For example, all the lamps 24 associated with the right side are turned on or alternatively, some lamps 24 are turned on, while the other are kept off.

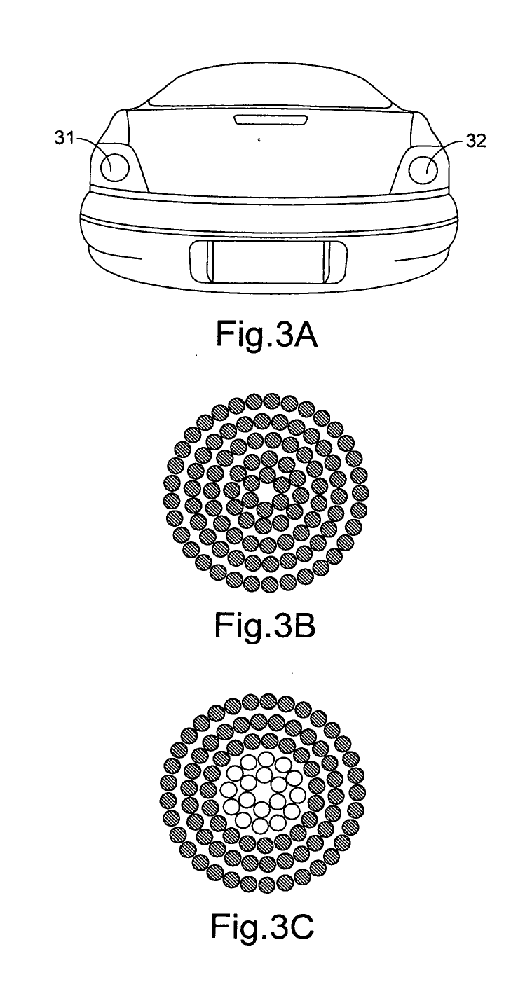

An example is shown in FIGS. 3A, 3B and 3C. In the example, an automobile (not labeled) comprises two turning indicators 31, 32 disposed at right and left rear corners of the automobile. Each turning indicator 31, 32 comprises a number (five in this case) of lamps arranged in a number of concentric circles, one surrounding the other, as shown in FIGS. 3B and 3C. “Hatched” indicates illuminating lamps, while “blank” indicates non-illuminating lamps. The manual operation of the indicator light switch 25 may switch, either simultaneously or in sequence, on some (FIG. 3C) or all (FIG. 3B) of the lamps of the associated turning indicator 31, 32.

On the other hand, in case the indicator light switch 25 is not actuated, when the steering wheel is rotated, the sensor 21 issues a signal to the microprocessor 22, which in turn, based on program or software or instructions pre-loaded therein and in accordance with the turning direction and turning angle, issue commands, which determines the number and locations of the lamps to be lighted, to the control unit 23. The control unit 23 then selectively lights on each lamp in accordance with the commands of the microprocessor 22.

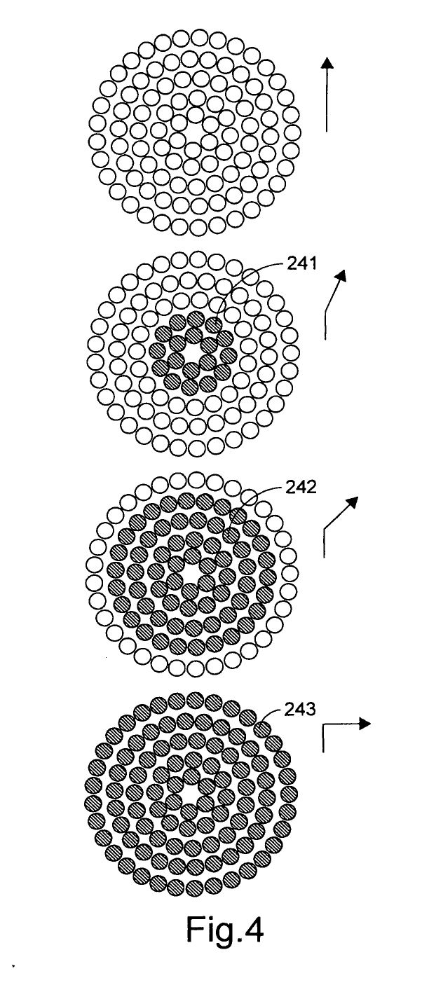

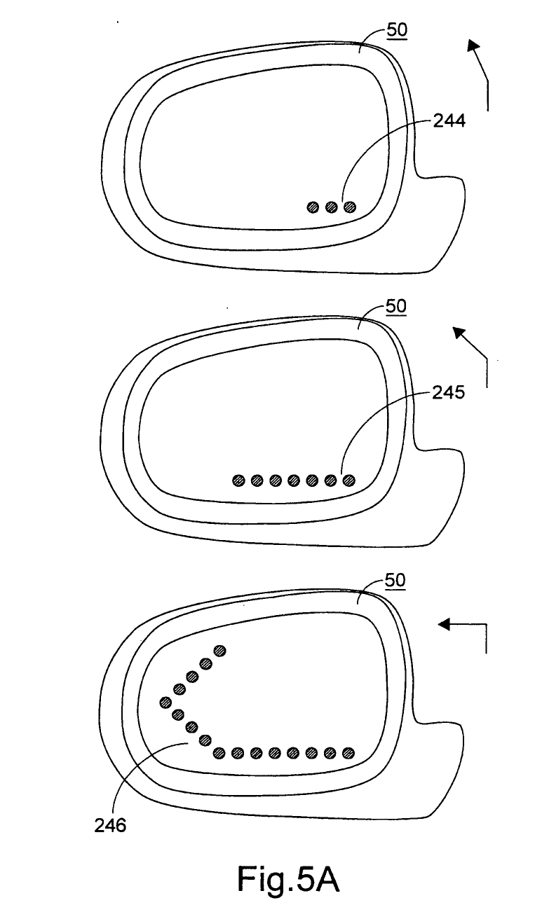

Also referring to FIG. 4A-4D, an example of a lighting mode for the lamps of the automobile indicator 232 is shown. When the automobile is moving straightforward, no lamp is turned on, as shown in FIGS. 4A. When the automobile makes a slight right turn, a small number of lamps, indicated by reference numeral 241 in FIG. 4B, which comprises the two most centrally-located circles, is illuminated to wam other drivers. If the vehicle is making further right turn, two more circles, indicated by reference numeral 242 in FIG. 4C, are lighted to indicate a right turn with a larger angle. When the automobile makes a sharp turn, all the lamps, indicated by reference numeral 243 in FIG. 4D, are turned on to exhibit prominent warning effect. By this way, other drivers can timely note how and what direction the automobile is moving.

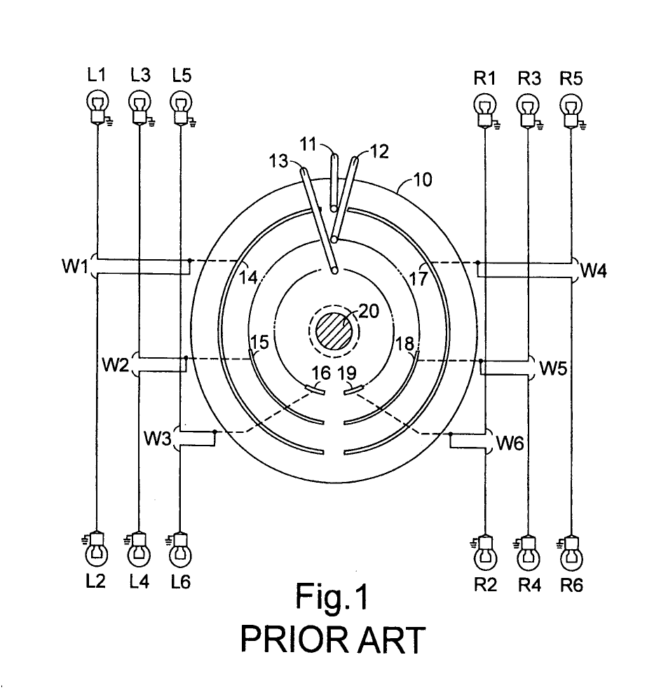

Besides the rear and front turning indicator lights, the automobile indicator of the present invention can be mounted to various positions on the automobile. For example, rearview mirror modules that are mounted to right and left sides of the automobile are one of the suitable places for the automobile indicator in accordance with the present invention. This is shown in FIGS. 5A-1 to 5A-3, 5B-1 to 5B-3, 5C and 5D.

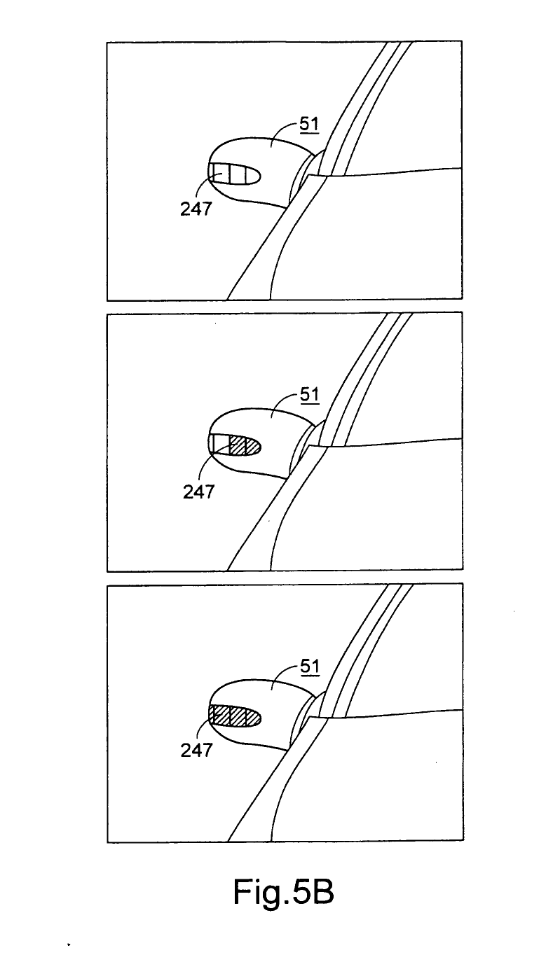

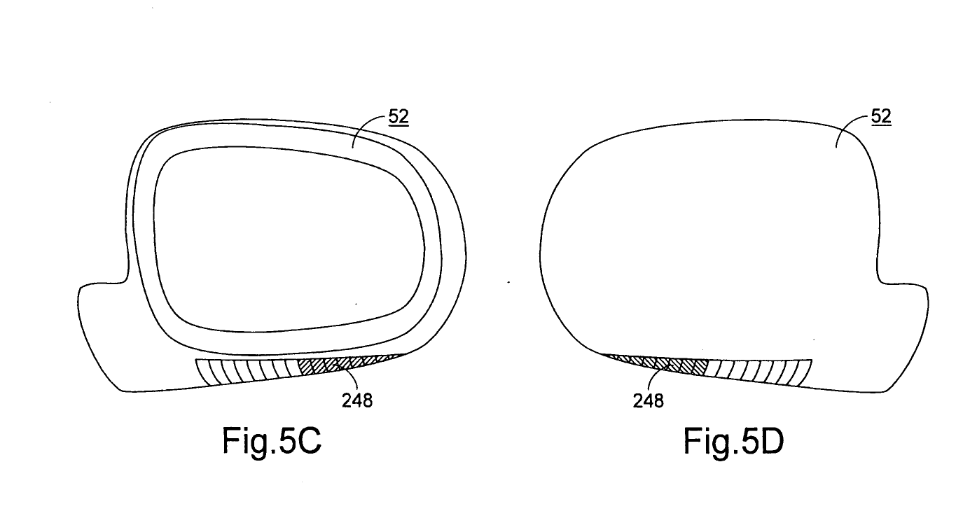

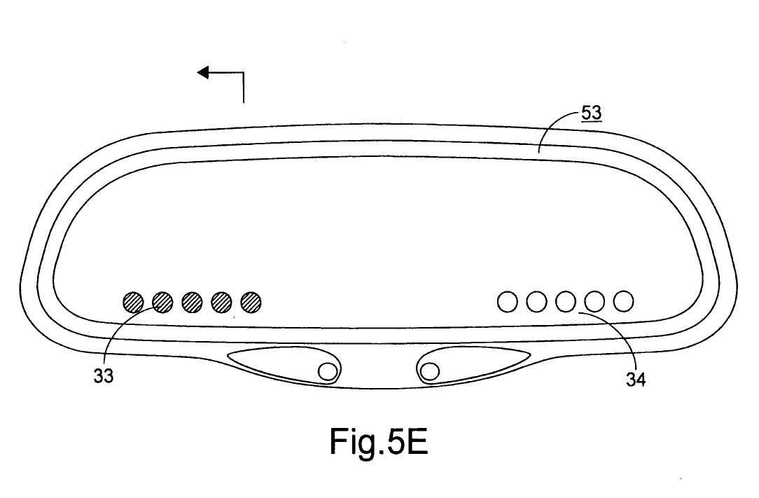

Referring to FIGS. 5A-1 to 5A-3, which shows a first example of mounting the automobile indicator of the present invention to a rearview mirror module 50, the automobile indicator of the present invention comprises a number of lamps mounted inside the rearview mirror module 50 while visible through the mirror. The lamps are arranged in a pointing angle comprised of two legs and a straight tail horizontally extending from an end of one leg of the angle. When the automobile makes a small angle turn, such as a slight left turn, only a portion of the lamps, designated by reference numeral 244 in FIG. 5A-1, illuminate. If the automobile makes further left turn, a larger portion of the lamps indicated by reference numeral 245 in FIGS. 5A-2, illuminate to indicate a left turn with a large angle. If the automobile makes a sharp turn, all the lamps indicated by reference numeral 246 in FIG. 5A-3, are turned on to exhibit prominent warning effect.

FIGS. 5B-1 to 5B-3 show another example in which the automobile indicator of the present invention is incorporated with a rearview mirror module, designated with reference numeral 51. Likewise, the automobile indicator of the present invention comprises a number of lamps 247 mounted in a line to a casing (not labeled) of the rearview mirror module 51 and facing a forwarding direction of the automobile. The lamps 247 that are arranged in a line are selectively illuminated in a portion-by-portion manner to show the angle of a turn. For example, the lamps 247 is lighted one after one to indicate the increasing angle of turning. No lamp 247 is lighted, as shown in FIG. 5B-1, when the automobile is moving straightforward. A first portion of the lamps 247, including two lamps 247 in this case, as shown in FIG. 5B-2, are lighted when the automobile make a small angle turning. When the automobile makes a sharp turn, all the lamps 247are lighted as shown in FIG. 5B-3.

FIGS. 5C and 5D shows a further example of incorporating the automobile indicator of the present invention to a rearview mirror module, which is designated with reference numeral 52 in the drawings. The turning indictor of the present invention comprises a number of lamps 248 mounted in a line along a lower edge of a casing of the rearview mirror module 52 whereby both the forward coming and the rearward-coming drivers can see the lamps 248. Although the automobile indicator illustrated in FIGS. 5C and 5D comprises lamps 248 of a number greater than that of the automobile indicator illustrated in FIG. 5B-1 to 5B-2, they operate with the same principle and thus no further detail is needed.

FIG. 5E shows a different example in which the automobile indicator of the present invention is incorporated in an interior rearview mirror module designated with reference numeral 53. The automobile indicator comprises a number of lamps divided into left turning indicator 33 and right turning indicator 34, each comprising a number of the lamps arranged in a line. When the automobile makes left turn, the lamps of the left turning indicator 33 are selectively lighted in a manner similar to that described with reference to FIGS. 5A-1 to 5A-3 and when the automobile makes right turn, the lamps of the right turning indicator 34 are selectively lighted in a similar manner. In addition, since the lighting of the lamps can be seen by the driver of the automobile, the driver may confirm the correct turning/lane-switching operation that is being taken by watching at the illuminating lamps on the interior rearview mirror module 53.

For an indication light is stipulated to be with a single color, such as orange or yellow color that is prevailing in the current automobile, the lamps can be of any kind of lighting cell that gives off the orange or yellow light, such as incandescent lamp, LED and LE cell. In case, lighting cells of bi-color or multiple-color are allowed, each lamp can be a bi-color or multiple-color lighting cell that gives off lights of at least two colors, such as orange light and another color of light. The control unit 23 (see FIG. 2) thus controls some selected ones of the lamps 24 to illuminate orange light in a first pattern in a first condition and to gives off different color light in a second pattern in a second condition. Alternatively, the two color lights can be used in combination in different conditions. For example, when the indicator light switch 25 is actuated, the first color light, such as organ light, is radiated by some selected ones of the lamps 24 in a predetermined, constant pattern, otherwise, such as when a detection signal is issued by the sensor 21, light of other color is radiated from the some of the lamps 24. In other words, the automobile indicator of the present invention performs dual functions, one for direction indication and the other for displaying dynamically the operation of turning. In the former case, the automobile indicator is enabled in a constant pattern to show that the automobile is going to take a turn in response to the actuation of the indicator light switch 25, while in the latter case, the automobile indicator may be enabled in a variable pattern to show that the vehicle is now turning and show the turning angle of the automobile as well.

It is to be noted that the automobile indicator of the present invention, when incorporated in a rearview mirror module, does not have to exhibit the function of direction indication that is controlled by the indicator light switch 25. In other words, the control unit 23 does not need to connect to the indicator light switch 25 whereby the automobile indicator simply performs automatic display of the turning degree of the automobile or the rotation angle of the steering wheel.

The automobile indicator of the present invention can be incorporated in other automobile parts, such as a brake light, rather than the regular indicator light, to indicate the turning direction and angle of the automobile or selectively indicating other message to other drivers, such as deceleration of the automobile.

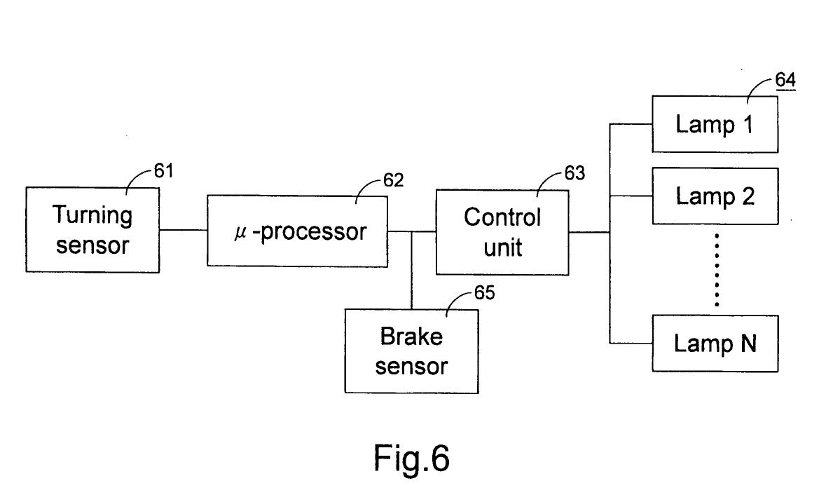

Referring to FIG. 6, which shows a second embodiment of the automobile indicator according to the present invention, the automobile indicator of the second embodiment is implemented as a brake light. In other words, the automobile indicator of the present invention performs two functions, one for brake indication and the other for dynamic turning indication. In the former case, the automobile indicator is enabled in a constant pattern to show that the vehicle is decelerated, while in the latter case, the automobile indicator is enabled in a variable pattern to show that the vehicle is turning, as well as turning angle thereof.

The automobile indicator, as shown in FIG. 6, comprises a turning sensor 61 electrically connected to a microprocessor 62 and a control unit 63 which, under the control of the microprocessor 62, controls lighting on/off of a number of lamps Lamp 1, Lamp 2, . . . , Lamp N, collectively referenced 64. A brake sensor 65 is electrically coupled to the control unit 63. All these members can be connected by wires or cables or alternatively, by a vehicular digital bus, such as a controller area network (CAN) and a vehicle area network (VAN) bus. The sensor 61, like the sensor 21, can be a 9850 Gen II Series sensor or

an NCAPS® Thin Profile sensor, which is mounted to a steering wheel (not shown) of an automobile for detecting a rotation angle of the steering wheel, and issuing an electrical signal, such as a digital signal, indicative of the turning direction and the turning angle according to the rotation angle of the steering wheel.

When the control unit 63 receives a signal indicative of the brake operation from the brake sensor 65, a control signal is generated and applied to select ones of the lamps 64 to form a constant pattern of lighting. For example, all the lamps 64 are turned on or only some specific lamps 64 are turned on. The schematic diagrams of FIGS. 3A-3C and 4A-4D can be employed again here for illustrating the dual-functional automobile indicator of the present invention except that the lights serve as brake lights instead of indicator lights.

When the brake sensor 65 detects the actuation of a brake pedal, a brake sensor 65 signals the control unit 63 of the brake operation so that the constant pattern associated with the braking operation is shown for each of the turning indicators 31, 32. The constant pattern can be exemplified as that shown in FIGS. 3B and 3C. On the other hand, if the brake operation is not performed by the driver, but rotation of the steering wheel is detected by the sensor 61, which indicates a turning-right operation of the automobile, the microprocessor 62, based on program or software or instructions preloaded therein, determines how many and which ones of the lamps 64 at the right side to be lighted in response to a signal issued by the sensor 61. Then, the control unit 63 lights on the lamps 64 of the right turning indicator 32 to show a desired pattern determined by and, preferably, dynamically changed in accordance with the microprocessor 62. The pattern-changing process is described with reference to FIG. 4 and thus no repeated description is needed here.

Generally, the brake light is stipulated to be red. Therefore, the automobile indicator according to this aspect of the present invention should be able to illuminate red light. In order to achieve this purpose, each single lamp of the automobile indicator of the present invention can be a filament lamp with red bulb or cover, a red light emitting diode (LED), an electro luminescence (EL) element, a fluorescent tube, and any other suitable lamp capable of illuminating red light. Alternatively, each lamp can be a bi-color or multi-color lamp, which selectively illuminates red light and another color of light. The control unit 63 (FIG. 6) controls selected ones of the lamps 64 to illuminate red light, forming a predetermined pattern, when the brake sensor 65 detects a brake operation, and illuminate another color of light, such as orange or yellow light, to show the turning angle.

Also referring to FIGS. 7A-1 to 7A-3, in addition to primary brake light, most automobile, especially passenger cars, are equipped with auxiliary brake lights. One of the auxiliary brake lights 641 is arranged at a position close to a rear windshield 70 of an automobile, preferably inside the automobile.

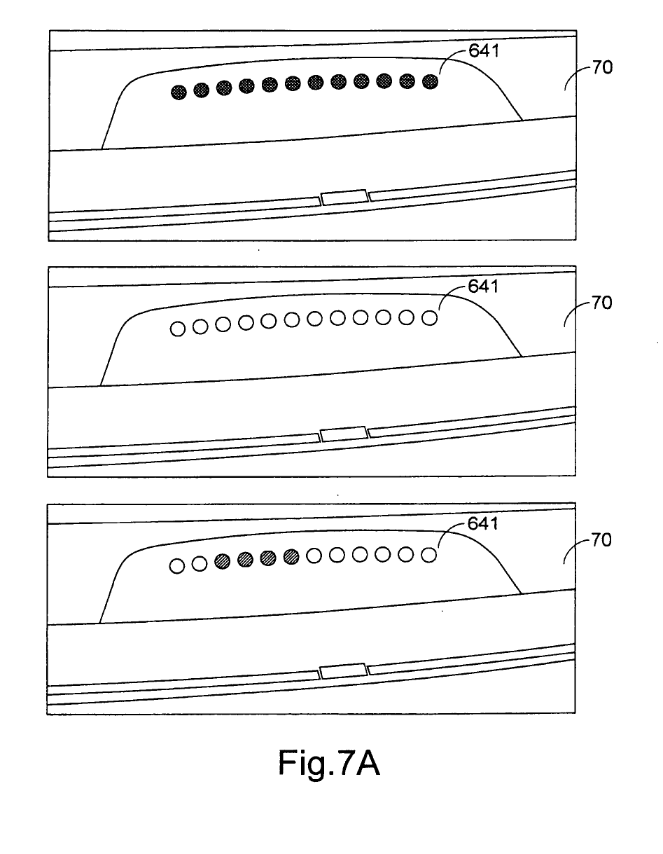

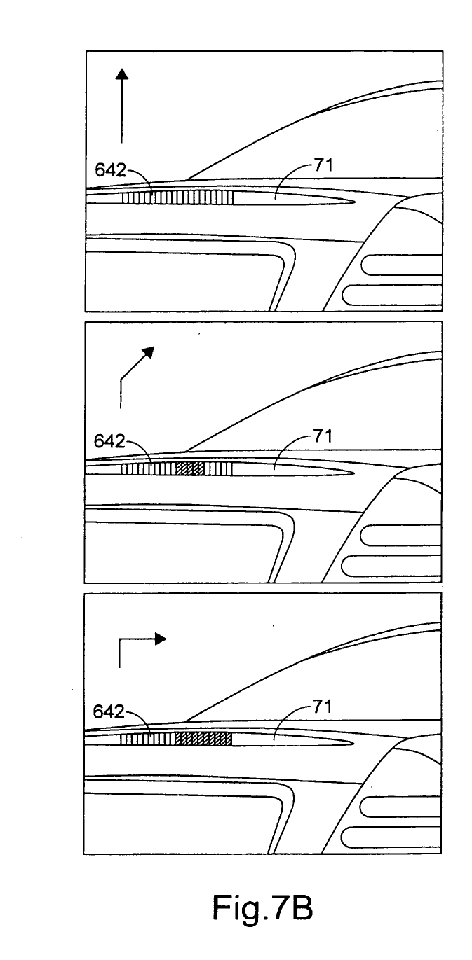

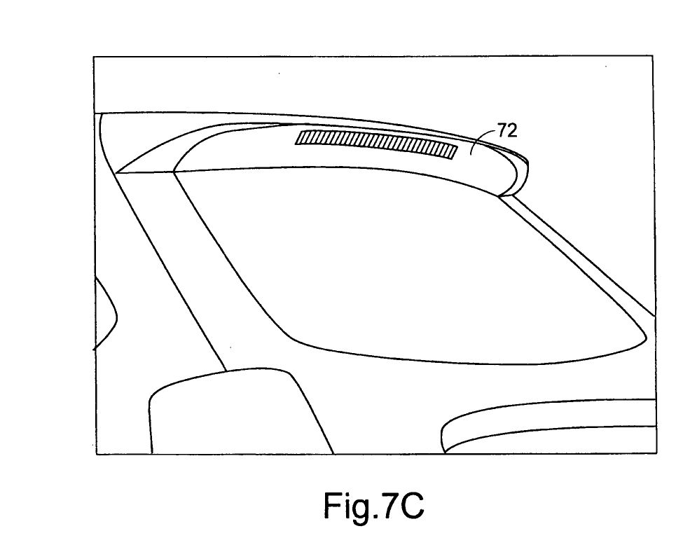

Another examples of mounting an auxiliary brake light to an automobile are shown in FIGS. 7B-1 to 7B-3 and FIG. 7C, respectively, where the auxiliary brake light is arranged on a rear spoiler of an automobile. In FIGS. 7B-1 to 7B-3, an auxiliary brake light, designated with reference numeral 642, is mounted on a rear wing 71 of an automobile. In FIG. 7C, an auxiliary brake light is mounted on an up door spoiler 72.

Referring back to FIGS. 7A-1 to 7A-3, when the control unit 63 receives a signal indicative of a brake operation detected by the brake sensor 65, a control signal is issued to turn on all lamps 641 to illuminate red light, as shown in FIG. 7A-1. When the car is released from the braking operation, all lamps 641 return back to non-illumination status. The non-illumination state of the lamps 641 also indicates a straightforward movement of the car as shown in FIG. 7A-2. In case the car makes a left turn, selected ones of the lamps 641, such as those located on the left half (or some of those located on the left half) of a linear array of the lamps 641, illuminate for example orange light to show the turning angle of the car. This is shown in FIG. 7A-3. The examples illustrated in FIGS. 7B1-1 to 7B-3 and 7C operate in the same manner as that of FIGS. 7A-1 to 7A-3.

An example of lighting pattern of the lamps includes lighting more lamps to indicate a larger angle turning as shown in FIGS. 7B-1 to 7B-3. In the example, the lamps are arranged in a linear array. In making a right turn, the lamps of the right half may sequentially lighted from the one located at the center of the linear array toward the leftmost one in a one by one manner or a two by two manner by shifting one lamp (in other words, one lamp is repeatedly lighted when shifting from first two lamps to next two lamps) or two lamps (in other words, no lamp is repeatedly lighted when shifting from the first two lamps to the next two lamps). This also applies to “left turning”, in which the lamps of the left half, rather than the right half, are sequentially lighted.

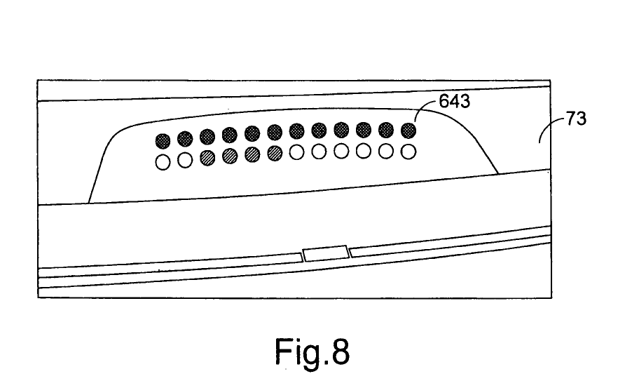

In the previous description, the lamps of the auxiliary braking light and the lamps of the automobile indicator of the present invention are integrated together. However, the lamps of the automobile indicator can be additionally provided and incorporated into the auxiliary brake light but separated from the lamps of the brake light. An example is shown in FIG. 8, wherein the lamps 643 of the automobile indicator are arranged in a linear array inside a casing of an auxiliary brake light below (or above) lamps of the auxiliary brake light 73. This allows the brake light 73 and the automobile indicator of the present invention to be operated simultaneously.

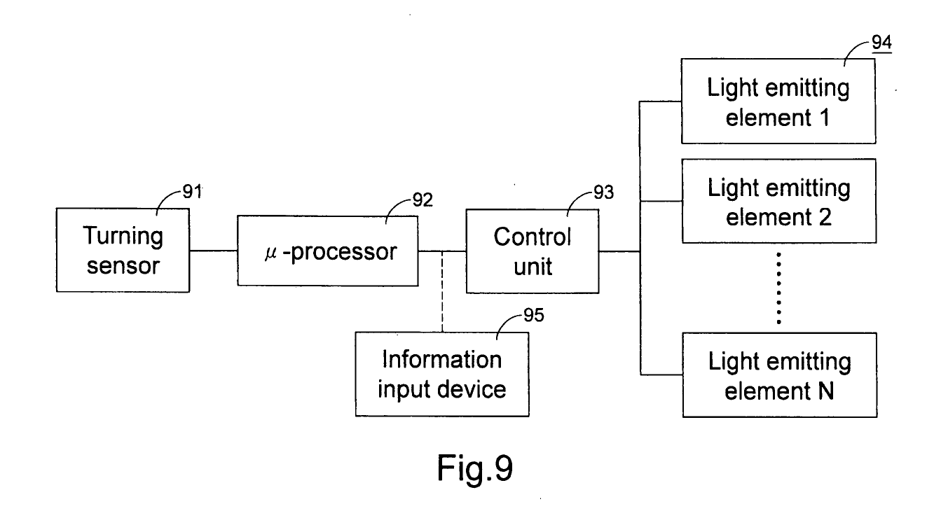

With reference to FIG. 9, an automobile indicator in accordance with a third embodiment of the present invention is shown, which incorporated with a head-up display that is generally projected on a front windscreen of an automobile. The third embodiment automobile indicator comprises a turning sensor 91 electrically connected to a microprocessor 92 and a control unit 93 that, under the control of the microprocessor 92, controls lighting on/off of a plurality of light-emitting elements 94 or lamps. The control unit 93 is optionally coupled to an information input device 95. The parts and components of the automobile indicator can be connected by wires or cables or alternatively, by means of a vehicular digital bus, such as a controller area network (CAN) and a vehicle area network (VAN) bus. The sensor 91, like the sensor 21 discussed with reference to FIG. 2, can be a 9850 Gen II Series sensor or an NCAPS® Thin Profile sensor, which is mounted to a steering wheel (not shown) of the automobile for detecting a rotation angle of the steering wheel and, in response thereto, generating an electrical signal, such as a digital signal, indicative of the turning direction and the turning angle of the automobile according to the rotation angle of the steering wheel.

The light-emitting elements 94 constitute partly the head-up display, and vary with the kinds of head-up displays. For example, the light-emitting elements 94 can be fluorescent tubes when the head-up display is a vacuum fluorescent display (VFD). Alternatively, the head-up display can be for example a digital light processor (DLP) display, a liquid crystal on silicon (LCOS) display, a thin film transistor liquid crystal display (TFTLCD) and a transparent liquid crystal display (transparent LCD), and has corresponding light-emitting elements 94. If the light-emitting elements 94 are additionally provided in the head-up display for specific use for showing the turning angle of the automobile, the control unit 93 does not have to communicate with the information input device 95.

When the control unit 93 receives a signal from the sensor 91 to indicate a turning-right operation of the vehicle, the microprocessor 92 determines how many and what ones of the light-emitting elements 94 that are located on the right side of the automobile are to actuated for illumination in response to the signal in connection with the turning direction and turning angle. The control unit 93 controls the light-emitting elements 94 of the automobile indicator in any desired scheme to show a desired lighting pattern under the control of the microprocessor 92 in accordance with program or software or instructions preloaded in the microprocessor 92.

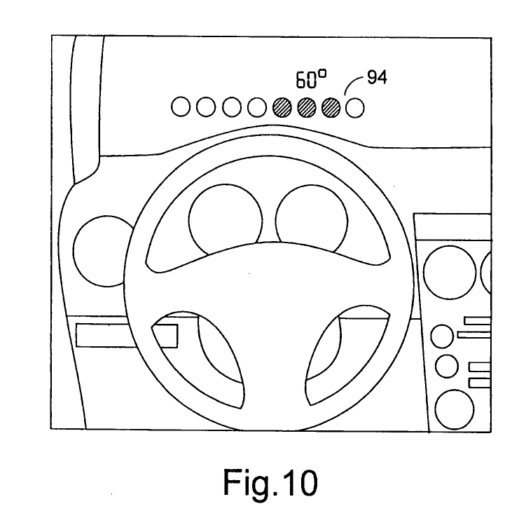

For example, as shown in FIG. 10, figures of a turning angle, such as 60° are shown in addition to the lighting of selected ones of the light-emitting elements 94. The lighting scheme of the lighting-emitting elements 94 is similar to those described previously and thus no repeated description is needed herein.

Alternatively, the light-emitting elements 94 can be parts of the existing light-emitting elements of the head-up display. Under this circumstance, it is preferred that the control unit 93 is further in communication with the information input device 95. When there is information to be shown on the display, the control unit 93 controls the light-emitting elements 94 to cooperate with other light-emitting elements to show the information. When there is no information to be displayed, the light-emitting elements 94 are used to show the turning angle as described above.

According to another aspect of the present invention, the microprocessor determines how many and which ones of the lamps are to be lighted based on the turning direction and turning angle of the automobile and further taking the speed of the automobile into account. Different ranges of speed of the automobile are associated with different patterns of lighting the light-emitting element. Thus, the drivers of the following cars can be informed of the speed of the leading car that is taking a turning operation of lane-switching operation. Driving safety is thus further enhanced.

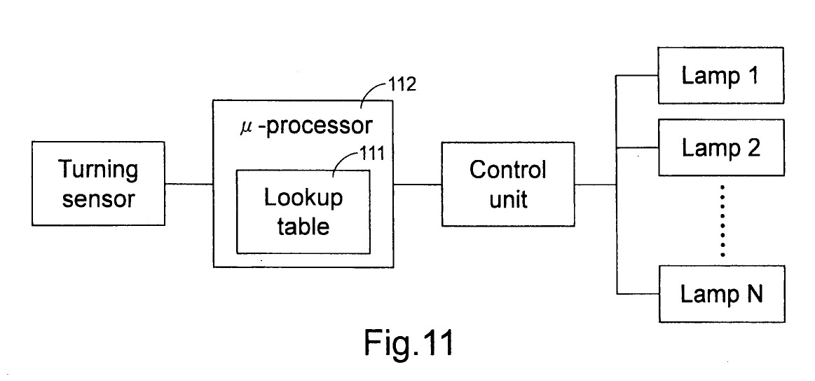

Also referring to FIG. 11, an automobile indicator in accordance with a fourth embodiment of the present invention is shown, comprising a turning sensor mounted to a steering wheel of an automobile for detection of rotation angle of the steering wheel and, in response thereto, issuing an electrical signal to a microprocessor 112 that comprises a look-up table 111 for the lighting pattern of a number of lamps Lamp 1, Lamp 2, . . . , Lamp N that are controlled by a control unit under the control of the microprocessor 112. The loop-up table 111 comprises a number of lighting schemes, each of which associates the number and location of the lamps with the turning angle and the speed of the automobile, whereby the microprocessor 112 selectively light the lamps via the control unit based on the schemes of the look-up table 111. By this way, the lamps are lighted in a first pattern when the automobile is moving at a first speed, and the lamps are lighted in a second pattern when the automobile is moving at a second speed. With the same turning direction and turning angle, if the first speed is for example higher than the second speed, then more lamps are lighted in the first pattern than in the second pattern. In case of different turning angle and turning direction, the lighting pattern may vary accordingly.

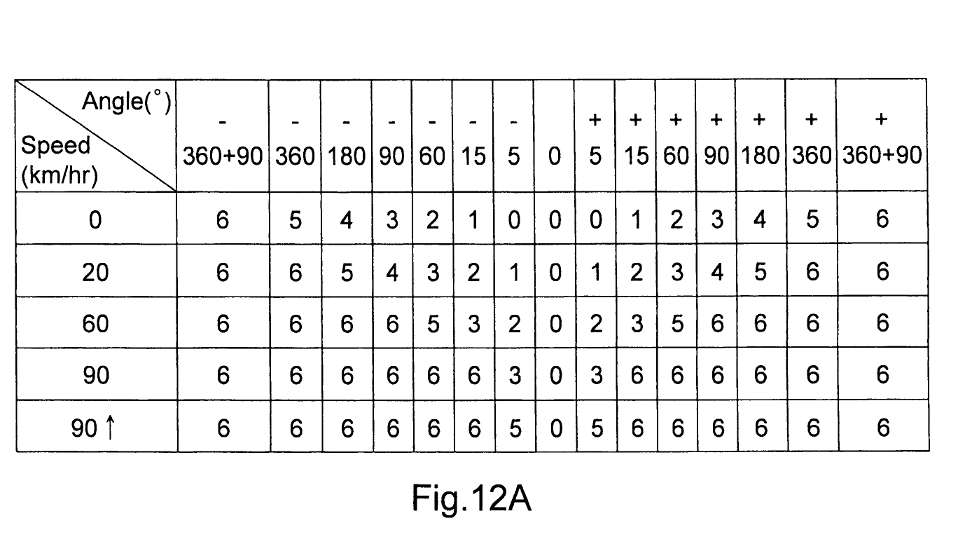

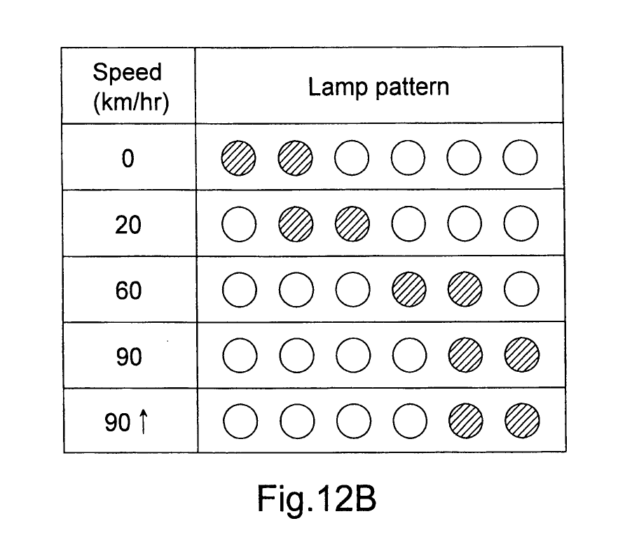

FIG. 12 A shows an example of the look-up table 111. The look-up table shown in FIG. 12A is very simple, only indicating the number of lamps to be lighted in association with particular turning angles and speeds. A description of the look-up table 111 illustrated in FIG. 12A will be given by considering the automobile indicator shown in FIGS. 7A-1 to 7A-3, which automobile indicator comprises a number of lamps 641 (twelve in this case) arranged in a linear array of the vehicle. Based on the look-up table, when an automobile is moving at a constant speed, for example 60 km/hr, the larger angle a turn is made, the greater number of lamps are lighted. For example, when the automobile is making a 5-degree right turn (+5°), two lamps at the right side are lighted. Under the same situation, a 15-degree right turn (+15°) causes three lamps at the right side to be lighted, while for a 60-degree right turn (+60°), five lamps are lighted. A straightforward movement (0°) of the automobile causes no lamp to be lighted, regardless the speed of the automobile.

In addition, in case of small angle right/left turn (+5°/−5°) under a motionless state, no lamp is turned on, while such a small angle right/left turn causes different numbers of the lamps to be lighted, in accordance with the automobile speed. This is because even a small angle turn will result in a significant effect if the automobile is moving at high speeds. For example, when the automobile speed is 20 km/hr, only one lamp at the right (or left) side is turned on to indicate the small angle right (or left) turn (+5° or −5°), while three lamps at the right side are turned on to prominently warn others when the speed of the automobile is as high as 90 km/hr.

Alternatively, the number of the lamps that are lighted can be maintained the same for different automobile speed, while the locations of the lamps that are lighted vary with the automobile speed. An example is shown in FIG. 12B. In this example, two adjacent lamps 121 are lighted together as a group associated with a particular speed or range of speed and the location of the illuminating lamps shifts from the rightmost to leftmost. The higher the automobile speed is, the larger the shift of the location of the illuminating lamps is done toward the leftmost location

Further, if the luminance of the lamps can be varied, then, if desired, the luminance of the illuminating lamps 121, rather than the location or the number, may vary with automobile speed to effectively indicate the automobile speed with the luminance of the lamps.

The above method for determining the number of illuminating lamps depending on both the turning angle and speed of an automobile is applicable to any of the embodiments described previously by providing proper look-up tables in the microprocessor. Basically, but not necessarily, the look-up tables are designed on the basis of the turning angles, automobile speeds and numbers of automobile indicator lamps.

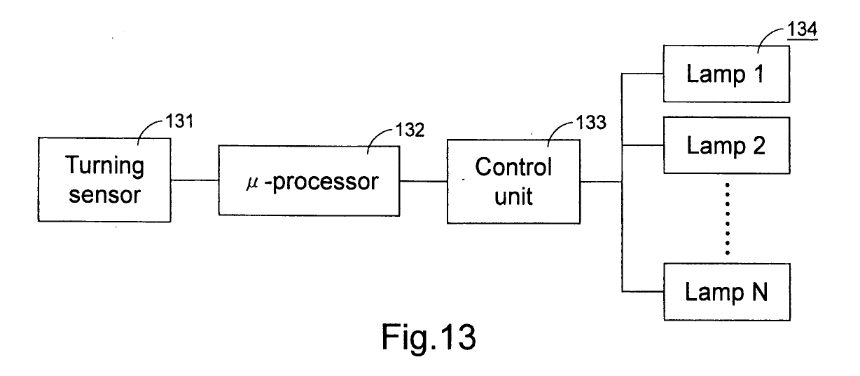

FIG. 13 shows a further embodiment of the automobile indicator according to the present invention, wherein the automobile indicator is made as parts for additionally and independently mounting to an automobile, rather than forming partly an existing part of the automobile, such as a regular indicator light, a brake light and a head-up display. The automobile indicator comprises a turning sensor 131 electrically coupled to a microprocessor 132 and a control unit 133 that controls, under the control of the microprocessor 132 a number of lamps 134. The connection between these parts is done with wires or cables. However, the connection can be also formed by means of a vehicular digital bus such as a controller area network (CAN) and a vehicle area network (VAN) bus.

The sensor 131 is mounted to a steering wheel (not shown) of an automobile for detecting a rotation angle of the steering wheel, and in response thereto, generating an electrical signal, such as a digital signal, indicative of the turning direction and the turning angle of the automobile according to the rotation angle of the steering wheel. A commercial sensor, such as a 9850 Gen II Series sensor or an NCAPS® Thin Profile sensor commercially available from BEI Technologies Inc. (California, USA), can be used to achieve the above purpose.

As an illustrative example, to make a right turn, the driver turns the steering wheel rightward. A signal is generated by the sensor 131, indicating the right turning of the automobile. The microprocessor 132, based on the program or software or instructions preloaded therein, determines how many and which ones of the lamps at the right side of the automobile to be lighted in response to the signal from the sensor 31 in connection with the turning direction, turning degree and preferably speed of the automobile. The control unit 133 variably turns on the lamps of the right turning indicator to show a desired pattern determined by the microprocessor 132.

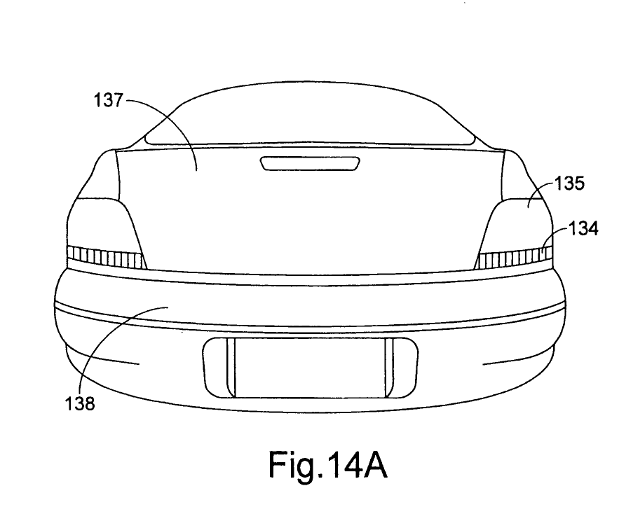

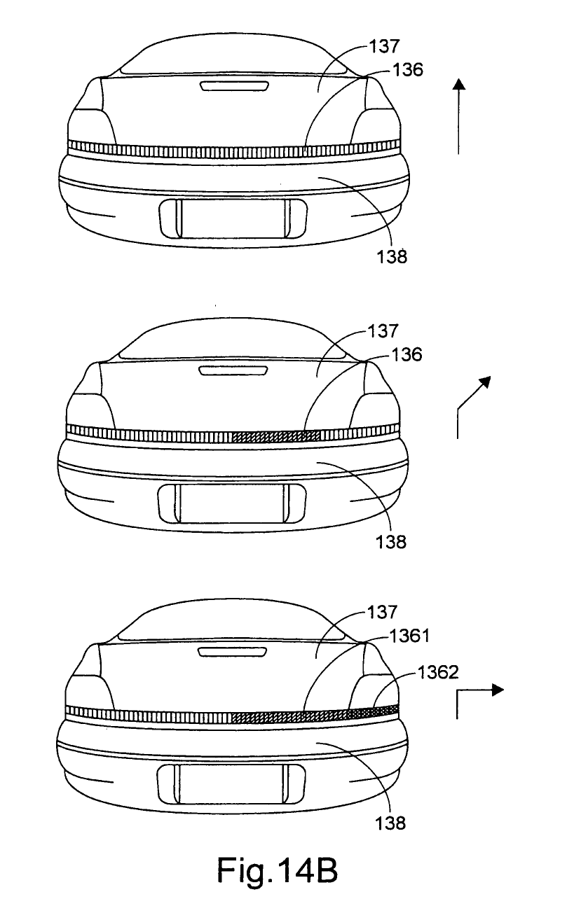

For example, as shown in FIG. 14A, the lamps 134 are arranged on a body of an automobile below a rear lamp assembly 135 comprising an indicator light, a backup light and a brake light. Reference numerals 137 and 138 designate a trunk lid and a bumper of the automobile.

FIGS. 14B-1 to 14B-3 show another example of mounting the lamps (which are designated with reference numeral 136 in FIGS. 14B-1 t- 14B-3) of the automobile indicator to the automobile body. The lamps 136 are arranged on the automobile body between a trunk lid 137 and a rear bumper 138. If desired, the lamps 136 may consist of more than one color to distinguish different levels of turning so as to make the turning indication even prominent. For example, in case the lamps arranged in a linear array, the right half of lamps is in connection with right turn indication, and the left ⅔ portion 1361 of lamps of the right half illuminate orange light while the right ⅓ portion 1362 of lamps illuminate red light to inform other drivers of a sharp turn.

The lamps, of course, can be mounted to any other suitable positions as long as they can hold attraction from other drivers. For example, the lamps can also be arranged on the automobile body between a hood and a front bumper and/or arranged under the headlight.

As mentioned above, the lamps of the automobile indicator of the present invention may be constructed to emit lights of different colors for different functions. For example, the color of light emitted in response to the operation of an indicator light switch or a brake operation can be different from that emitted in response to the turning angle. In order to attract the attention of other drivers, the colors of the light emitted in response to different turning angles can be different as described above with reference to FIGS. 14B-1 to 14B-3. Alternatively, the colors of light may vary with turning angles. For example, when the lamps 139 are used to show the brake operation, as in Case I, the color of light is red. When the lamps 139 are use a small angle turning operation, the color is yellow as shown in Case II. When the lamps 139 are used to show a large angle turning operation, the color of light becomes red again, as in Case III.

In addition to color, the luminance of the light can also vary with the range of turning angle and/or speed of an automobile.

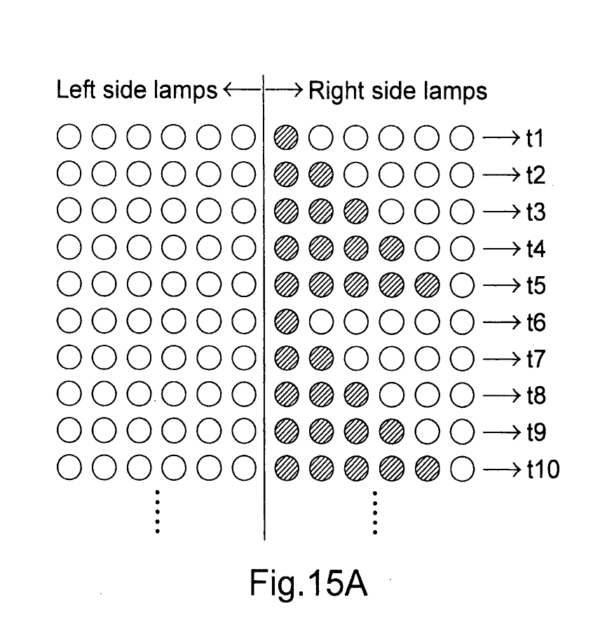

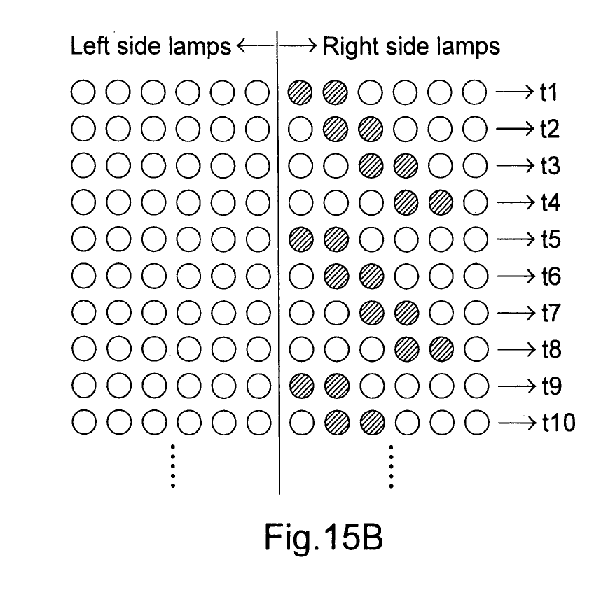

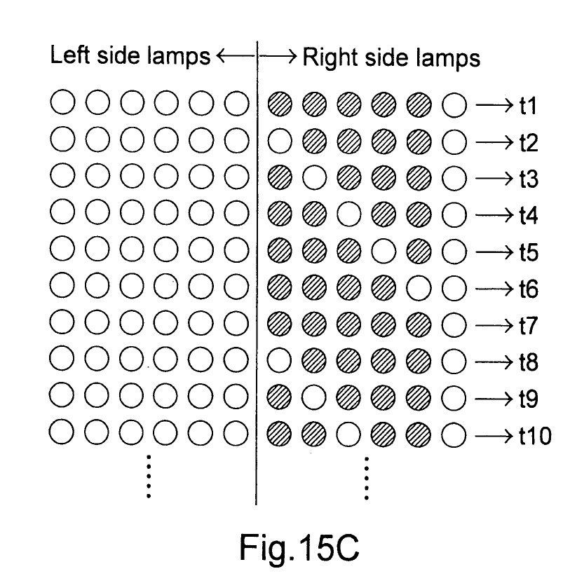

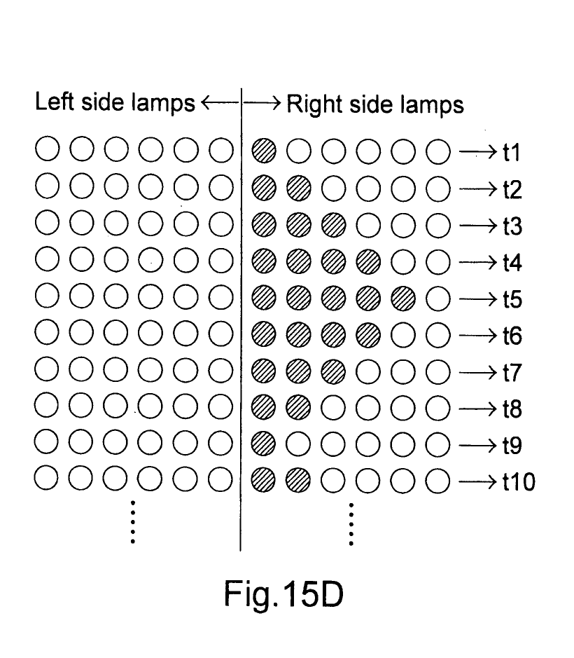

Referring to FIGS. 15A-15D, in order to further attract attention from other drivers, a plurality of different lighting patterns/schemes can be sequentially display for a specific turning direction and a specific turning angle. For example, the lamps of any of the above-described embodiments can be made to sequentially twinkle. The transformation between the plurality of lighting patterns or the twinkling of the lamps follows a predetermined rule. For example, an automobile is traveling at a speed of 60 km/hr and is making a right turn at an angle of 60 degrees. According to the lookup table illustrated in FIG. 12A, five lamps at the right side of the automobile are turned on. In this embodiment, the five lamps sequentially twinkle instead of continuous emission of light.

The twinkling rate is preferably made dependent upon the speed of the automobile and is in such a high rate whereby other drivers see the lamps running thereby attracting the attention of the other drivers. For example, the time interval t for changing patterns, that is difference between the time when a first pattern is being taken and the time when a next pattern is being taken, such as t=t2−t1=t3−t2=. . . =t10−t9, is 0.5 seconds for the automobile speed of 20 km/hr and the time interval t is reduced to 0.25 seconds for the automobile speed of 60 km/hr.

In the example of FIG. 15A, the number of lamps that are twinkling is increased from one to two and then three and four in sequence. The cycle repeats. In the example of FIG. 15B, two lamps as a pair are twinkling together and then the twinkling lamps shifts to next pair wherein the original pair and the next pair share one common lamp. The shifting of twinkling pairs moves from for example the leftmost position toward the rightmost position. The example of FIG. 15C is exactly an reverse operation of FIG. 15A wherein the number of the twinkling lamps is decremented from for example four to one and the cycle repeats. FIG. 15D shows a variation of FIG. 15A, wherein after the number of twinkling lamps is increased to four, the number is decremented by one for each change of lighting pattern. The cycle including both number increasing and number decreasing repeats itself.

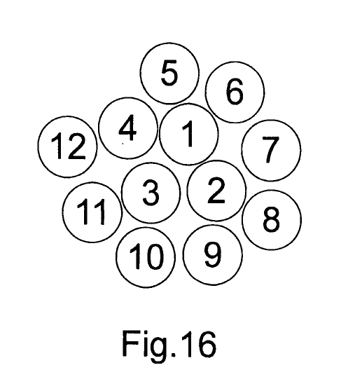

Although a linear arrangement of the lamps is exemplified in FIGS. 15A-15D for illustrating the twinkling action of the lamps, the twinkling principal may be applied to various lamp arrangements by those skilled in the art. For example, as shown in FIG. 16, the lamps are arranged in a swirl configuration. The lighting schemes illustrated in FIGS. 15A-15D can also be applied here. The numbers labeled inside the lamps indicate the illuminating sequence of the lamps.

The present invention provides various automobile indicators capable of automatically showing the turning angle of an automobile. The automobile indicator can be implemented in the existing vehicular lamps, or incorporated into an existing vehicular accessory, utilizing special flashing effects to make the turning indication prominent, allowing the driver himself to see the turning indication, and/or operating on the basis of the automobile speed. By the automobile indicator of the present invention, the movement of an automobile can be effectively monitored so as to enhance the driving safety.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures.

1. An automobile indicator comprising:
sensing means for detecting an automobile status parameter and issuing a detection signal corresponding to detection result;
control means receiving the signal from the sensing means and issuing a control signal based on instructions preloaded therein; and
a plurality of light-emitting elements adapted to be mounted to an automobile, the light-emitting elements being controlled by the control signal to be selectively lighted in accordance with a first scheme corresponding to the control signal by changing a lighting parameter.

2. The automobile indicator as claimed in claim 1, wherein the first scheme comprises at least a first lighting pattern.

3. The automobile indicator as claimed in claim 1, wherein the automobile status parameter comprises turning angle of the automobile.

4. The automobile indicator as claimed in claim 1, wherein the automobile status parameter comprises turning direction of the automobile.

5. The automobile indicator as claimed in claim 1, wherein the automobile status parameter comprises speed of the automobile.

6. The automobile indicator as claimed in claim 1, wherein the lighting parameter comprises number of the light-emitting elements that are lighted.

7. The automobile indicator as claimed in claim 1, wherein the lighting parameter comprises locations of the light-emitting elements that are lighted.

8. The automobile indicator as claimed in claim 1, wherein the lighting parameter comprises luminance of the light-emitting elements that are lighted.

9. The automobile indicator as claimed in claim 1, wherein the lighting parameter comprises color of light emitted from the light-emitting elements that are lighted.

10. The automobile indicator as claimed in claim 2, wherein the light-emitting elements are divided into first and second groups and wherein the first lighting pattern comprises lighting the first and second groups in sequence.

11. The automobile indicator as claimed in claim 10, wherein first scheme comprises the first lighting pattern that is cyclically repeated.

12. The automobile indicator as claimed in claim 10, wherein the first scheme comprises the first lighting pattern and a second lighting pattern that is a reversal of the first lighting pattern.

13. The automobile indicator as claimed in claim 12, wherein the first scheme comprises the first lighting pattern followed by the second pattern and a repeat of both the first and second patterns.

14. The automobile indicator as claimed in claim 10, wherein the first scheme comprises the first lighting pattern and a second lighting pattern that is different from the first lighting pattern.

15. The automobile indicator as claimed in claim 14, wherein the first scheme comprises the first lighting pattern followed by the second pattern and a repeat of both the first and second patterns.

16. The automobile indicator as claimed in claim 10, wherein the first and second groups share at least one common light-emitting element.

17. The automobile indicator as claimed in claim 10, wherein the first and second groups are comprised of different ones of the light-emitting elements.

18. The automobile indicator as claimed in claim 2, wherein the light-emitting elements are divided into first and second groups and wherein the first lighting pattern comprises lighting the first group initially and then lighting the second group additionally.

19. The automobile indicator as claimed in claim 18, wherein first scheme comprises the first lighting pattern that is cyclically repeated.

20. The automobile indicator as claimed in claim 18, wherein the first scheme comprises the first lighting pattern and a second lighting pattern that is a reversal of the first lighting pattern.

21. The automobile indicator as claimed in claim 20, wherein the first scheme comprises the first lighting pattern followed by the second pattern and a repeat of both the first and second patterns

22. The automobile indicator as claimed in claim 18, wherein the first scheme comprises the first lighting pattern and a second lighting pattern that is different from the first lighting pattern.

23. The automobile indicator as claimed in claim 22, wherein the first scheme comprises the first lighting pattern followed by the second pattern and a repeat of both the first and second patterns.

24. The automobile indicator as claimed in claim 18, wherein the first and second groups share at least one common light-emitting element.

25. The automobile indicator as claimed in claim 18, wherein the first and second groups are comprised of different ones of the light-emitting elements.

26. The automobile indicator as claimed in claim 2, wherein the light-emitting elements are arranged in a linear array.

27. The automobile indicator as claimed in claim 26, wherein the light-emitting elements of the linear array are divided into first and second groups and wherein the first lighting pattern comprises lighting the first and second groups in sequence.

28. The automobile indicator as claimed in claim 27, wherein first scheme comprises the first lighting pattern that is cyclically repeated.

29. The automobile indicator as claimed in claim 27, wherein the first scheme comprises the first lighting pattern and a second lighting pattern that is a reversal of the first lighting pattern.

30. The automobile indicator as claimed in claim 29, wherein the first scheme comprises the first lighting pattern followed by the second pattern and a repeat of both the first and second patterns

31. The automobile indicator as claimed in claim 27, wherein the first scheme comprises the first lighting pattern and a second lighting pattern that is different from the first lighting pattern.

32. The automobile indicator as claimed in claim 31, wherein the first scheme comprises the first lighting pattern followed by the second pattern and a repeat of both the first and second patterns.

33. The automobile indicator as claimed in claim 27, wherein the first and second groups share at least one common light-emitting element.

34. The automobile indicator as claimed in claim 27, wherein the first and second groups are comprised of different ones of the light-emitting elements.

35. The automobile indicator as claimed in claim 26, wherein the light-emitting elements are divided into first and second groups and wherein the first lighting pattern comprises lighting the first group initially and then lighting the second group additionally.

36. The automobile indicator as claimed in claim 35, wherein first scheme comprises the first lighting pattern that is cyclically repeated.

37. The automobile indicator as claimed in claim 35, wherein the first scheme comprises the first lighting pattern and a second lighting pattern that is a reversal of the first lighting pattern.

38. The automobile indicator as claimed in claim 37, wherein the first scheme comprises the first lighting pattern followed by the second pattern and a repeat of both the first and second patterns

39. The automobile indicator as claimed in claim 35, wherein the first scheme comprises the first lighting pattern and a second lighting pattern that is different from the first lighting pattern.

40. The automobile indicator as claimed in claim 39, wherein the first scheme comprises the first lighting pattern followed by the second pattern and a repeat of both the first and second patterns.

41. The automobile indicator as claimed in claim 35, wherein the first and second groups share at least one common light-emitting element.

42. The automobile indicator as claimed in claim 35, wherein the first and second groups are comprised of different ones of the light-emitting elements.

43. The automobile indicator as claimed in claim 27, wherein the linear array comprises a right half and a left half respectively located on right and left portions of the automobile.

44. The automobile indicator as claimed in claim 43, wherein the light-emitting elements of each half of the linear array are divided into first and second groups and wherein the first lighting pattern comprises lighting the first and second groups of each half in sequence in a direction away from the other half.

45. The automobile indicator as claimed in claim 43, wherein the light-emitting elements of each half of the linear array are divided into first and second groups and wherein the first lighting pattern comprises lighting the first and second groups of each half in sequence in a direction toward the other half.

46. The automobile indicator as claimed in claim 44, wherein first scheme comprises the first lighting pattern that is cyclically repeated.

47. The automobile indicator as claimed in claim 44, wherein the first scheme comprises the first lighting pattern and a second lighting pattern that is a reversal of the first lighting pattern.

48. The automobile indicator as claimed in claim 47, wherein the first scheme comprises the first lighting pattern followed by the second pattern and a repeat of both the first and second patterns

49. The automobile indicator as claimed in claim 44, wherein the first scheme comprises the first lighting pattern and a second lighting pattern that is different from the first lighting pattern.

50. The automobile indicator as claimed in claim 49, wherein the first scheme comprises the first lighting pattern followed by the second pattern and a repeat of both the first and second patterns.

51. The automobile indicator as claimed in claim 44, wherein the first and second groups share at least one common light-emitting element.

52. The automobile indicator as claimed in claim 44, wherein the first and second groups are comprised of different ones of the light-emitting elements.

53. The automobile indicator as claimed in claim 44, wherein the light-emitting elements are divided into first and second groups and wherein the first lighting pattern comprises lighting the first group initially and then lighting the second group additionally.

54. The automobile indicator as claimed in claim 53, wherein first scheme comprises the first lighting pattern that is cyclically repeated.

55. The automobile indicator as claimed in claim 53, wherein the first scheme comprises the first lighting pattern and a second lighting pattern that is a reversal of the first lighting pattern.

56. The automobile indicator as claimed in claim 55, wherein the first scheme comprises the first lighting pattern followed by the second pattern and a repeat of both the first and second patterns

57. The automobile indicator as claimed in claim 53, wherein the first scheme comprises the first lighting pattern and a second lighting pattern that is different from the first lighting pattern.

58. The automobile indicator as claimed in claim 57, wherein the first scheme comprises the first lighting pattern followed by the second pattern and a repeat of both the first and second patterns.

59. The automobile indicator as claimed in claim 53, wherein the first and second groups share at least one common light-emitting element.

60. The automobile indicator as claimed in claim 53, wherein the first and second groups are comprised of different ones of the light-emitting elements.

61. The automobile indicator as claimed in claim 45, wherein first scheme comprises the first lighting pattern that is cyclically repeated.

62. The automobile indicator as claimed in claim 45, wherein the first scheme comprises the first lighting pattern and a second lighting pattern that is a reversal of the first lighting pattern.

63. The automobile indicator as claimed in claim 62, wherein the first scheme comprises the first lighting pattern followed by the second pattern and a repeat of both the first and second patterns

64. The automobile indicator as claimed in claim 45, wherein the first scheme comprises the first-lighting pattern and a second lighting pattern that is different from the first lighting pattern.

65. The automobile indicator as claimed in claim 64, wherein the first scheme comprises the first lighting pattern followed by the second pattern and a repeat of both the first and second patterns.

66. The automobile indicator as claimed in claim 45, wherein the first and second groups share at least one common light-emitting element.

67. The automobile indicator as claimed in claim 45, wherein the first and second groups are comprised of different ones of the light-emitting elements.

68. The automobile indicator as claimed in claim 45, wherein the light-emitting elements are divided into first and second groups and wherein the first lighting pattern comprises lighting the first group initially and then lighting the second group additionally.

69. The automobile indicator as claimed in claim 68, wherein first scheme comprises the first lighting pattern that is cyclically repeated.

70. The automobile indicator as claimed in claim 68, wherein the first scheme comprises the first lighting pattern and a second lighting pattern that is a reversal of the first lighting pattern.

71. The automobile indicator as claimed in claim 70, wherein the first scheme comprises the first lighting pattern followed by the second pattern and a repeat of both the first and second patterns

72. The automobile indicator as claimed in claim 68, wherein the first scheme comprises the first lighting pattern and a second lighting pattern that is different from the first lighting pattern.

73. The automobile indicator as claimed in claim 72, wherein the first scheme comprises the first lighting pattern followed by the second pattern and a repeat of both the first and second patterns.

74. The automobile indicator as claimed in claim 68, wherein the first and second groups share at least one common light-emitting element.

75. The automobile indicator as claimed in claim 68, wherein the first and second groups are comprised of different ones of the light-emitting elements.

76. The automobile indicator as claimed in claim 2, wherein the light-emitting elements are arranged in a number of concentric circles.

77. The automobile indicator as claimed in claim 76, wherein the circles of the light-emitting elements are divided into first and second groups and wherein the first lighting pattern comprises lighting the first and second groups in sequence.

78. The automobile indicator as claimed in claim 77, wherein first scheme comprises the first lighting pattern that is cyclically repeated.

79. The automobile indicator as claimed in claim 77, wherein the first scheme comprises the first lighting pattern and a second lighting pattern that is a reversal of the first lighting pattern.

80. The automobile indicator as claimed in claim 79, wherein the first scheme comprises the first lighting pattern followed by the second pattern and a repeat of both the first and second patterns

81. The automobile indicator as claimed in claim 77, wherein the first scheme comprises the first lighting pattern and a second lighting pattern that is different from the first lighting pattern.

82. The automobile indicator as claimed in claim 81, wherein the first scheme comprises the first lighting pattern followed by the second pattern and a repeat of both the first and second patterns.

83. The automobile indicator as claimed in claim 77, wherein the first and second groups share at least one common circle of the light-emitting elements.

84. The automobile indicator as claimed in claim 77, wherein the first and second groups are comprised of different circles of the light-emitting elements.

85. The automobile indicator as claimed in claim 76, wherein the circles of the light-emitting elements are divided into first and second groups and wherein the first lighting pattern comprises lighting the first group initially and then lighting the second group additionally.

86. The automobile indicator as claimed in claim 85, wherein first scheme comprises the first lighting pattern that is cyclically repeated.

87. The automobile indicator as claimed in claim 85, wherein the first scheme comprises the first lighting pattern and a second lighting pattern that is a reversal of the first lighting pattern.

88. The automobile indicator as claimed in claim 87, wherein the first scheme comprises the first lighting pattern followed by the second pattern and a repeat of both the first and second patterns

89. The automobile indicator as claimed in claim 85, wherein the first scheme comprises the first lighting pattern and a second lighting pattern that is different from the first lighting pattern.

90. The automobile indicator as claimed in claim 89, wherein the first scheme comprises the first lighting pattern followed by the second pattern and a repeat of both the first and second patterns.

91. The automobile indicator as claimed in claim 85, wherein the first and second groups share at least one common circle of the light-emitting elements.

92. The automobile indicator as claimed in claim 85, wherein the first and second groups are comprised of different circles of the light-emitting elements.

93. The automobile indicator as claimed in claim 2, wherein the light-emitting elements are arranged in a swirl configuration.

94. The automobile indicator as claimed in claim 93, wherein the light-emitting elements of the linear array are divided into first and second groups and wherein the first lighting pattern comprises lighting the first and second groups in sequence.

95. The automobile indicator as claimed in claim 94, wherein first scheme comprises the first lighting pattern that is cyclically repeated.

96. The automobile indicator as claimed in claim 94, wherein the first scheme comprises the first lighting pattern and a second lighting pattern that is a reversal of the first lighting pattern.

97. The automobile indicator as claimed in claim 96, wherein the first scheme comprises the first lighting pattern followed by the second pattern and a repeat of both the first and second patterns

98. The automobile indicator as claimed in claim 94, wherein the first scheme comprises the first lighting pattern and a second lighting pattern that is different from the first lighting pattern.

99. The automobile indicator as claimed in claim 98, wherein the first scheme comprises the first lighting pattern followed by the second pattern and a repeat of both the first and second patterns.

100. The automobile indicator as claimed in claim 94, wherein the first and second groups share at least one common light-emitting element.

101. The automobile indicator as claimed in claim 94, wherein the first and second groups are comprised of different ones of the light-emitting elements.

102. The automobile indicator as claimed in claim 93, wherein the light-emitting elements are divided into first and second groups and wherein the first lighting pattern comprises lighting the first group initially and then lighting the second group additionally.

103. The automobile indicator as claimed in claim 102, wherein first scheme comprises the first lighting pattern that is cyclically repeated.

104. The automobile indicator as claimed in claim 102, wherein the first scheme comprises the first lighting pattern and a second lighting pattern that is a reversal of the first lighting pattern.

105. The automobile indicator as claimed in claim 104, wherein the first scheme comprises the first lighting pattern followed by the second pattern and a repeat of both the first and second patterns

106. The automobile indicator as claimed in claim 102, wherein the first scheme comprises the first lighting pattern and a second lighting pattern that is different from the first lighting pattern.

107. The automobile indicator as claimed in claim 106, wherein the first scheme comprises the first lighting pattern followed by the second pattern and a repeat of both the first and second patterns.

108. The automobile indicator as claimed in claim 102, wherein the first and second groups share at least one common light-emitting element.

109. The automobile indicator as claimed in claim 102, wherein the first and second groups are comprised of different ones of the light-emitting elements.

110. The automobile indicator as claimed in claim 1, wherein the light-emitting elements continuously give off light when lighted.

111. The automobile indicator as claimed in claim 1, wherein the light-emitting elements twinkle when lighted.
